(19) United States
(12) Patent Application Publication
(10) Pub. No.: US 2011/0155690 A1
(43) Pub. Date: Jun. 30, 2011

(54) POLISHING METHOD

(76) Inventor: Norihito YAMAGUCHI, Wakayama (JP)

(21) Appl. No.: 12/968,010

(22) Filed: Dec. 14, 2010

(30) Foreign Application Priority Data
Dec. 25, 2009 (JP) 2009-294209

(51) Int. Cl. G11B 5/84; C23F 1/20

(52) U.S. Cl. 216/22; 216/53

(57) ABSTRACT

The present invention relates to a method for polishing a substrate to be polished, including polishing a Ni—P-plated aluminum alloy substrate as the substrate to be polished while keeping a polishing composition in contact with a polishing pad. The polishing composition contains an abrasive, an acid, an oxidizing agent, a heterocyclic aromatic compound, an aliphatic amine compound or alicyclic amine compound, and water. The heterocyclic aromatic compound includes two or more nitrogen atoms in its ring structure, the aliphatic amine compound or alicyclic amine compound includes two to four nitrogen atoms in its molecules, and the polishing composition has a pH of 3.0 or less.

### BACKGROUND OF INVENTION

1. Field of the Invention

The present invention relates to a polishing composition for a Ni—P-plated aluminum alloy substrate, a polishing method and a method for producing a magnetic disk substrate using the polishing composition.

2. Description of Related Art

With the recent advances in the reduction in size and the increase in capacity of magnetic disk drives, there is a need to increase the recording density. To increase the recording density, techniques for further reducing the flying height of magnetic heads are being developed so as to decrease the unit recording area and improve the detection sensitivity for a weakened magnetic signal. In order to take measures for reducing the flying height of magnetic heads and ensuring the recording area, the requirements for magnetic disk substrates are becoming increasingly stringent, with regard to the improvement of smoothness and flatness (the reduction of surface roughness, waviness, and roll-off) and the reduction of defects (the reduction of scratches, protrusions, pits and the like). To meet such requirements, polishing compositions containing azoles such as benzotriazole (BTA) have been suggested as polishing compositions that can reduce scratches (see JP 2007-92064A, for example).

On the other hand, for CMP processing of semiconductor devices which requires properties different from those required in polishing magnetic disk substrates, polishing compositions for polishing and removing copper films, bather layers of a tantalum compound, and insulating layers of SiO₂ are disclosed. Specifically, disclosed are polishing compositions containing colloidal silica, oxalic acid, ethylenediamine and benzotriazole, which can improve dishing and erosion (JP 2001-089747 A and JP 2004-311484 A).

### SUMMARY OF THE INVENTION

Viewed from one aspect, the present invention relates to a polishing composition for a Ni—P-plated aluminum alloy substrate, which contains an abrasive, an acid, an oxidizing agent, a heterocyclic aromatic compound, an aliphatic amine compound or alicyclic amine compound, and water. The heterocyclic aromatic compound includes two or more nitrogen atoms in its ring structure, the aliphatic amine compound or alicyclic amine compound includes two to four nitrogen atoms in its molecules, and the polishing composition has a pH of 3.0 or less.

Viewed from another aspect, the present invention relates to a method for producing a magnetic disk substrate, which includes a step of polishing a Ni—P-plated aluminum alloy substrate using the polishing composition of the present invention.

Viewed from still another aspect, the present invention relates to a method for polishing a substrate to be polished, which includes polishing a Ni—P-plated aluminum alloy substrate as the substrate to be polished while keeping a polishing composition in contact with a polishing pad. The polishing composition contains an abrasive, an acid, an oxidizing agent, a heterocyclic aromatic compound, an aliphatic amine compound or alicyclic amine compound, and water. The heterocyclic aromatic compound includes two or more nitrogen atoms in its ring structure, the aliphatic amine compound or alicyclic amine compound includes two to four nitrogen atoms in its molecules, and the polishing composition has a pH of 3.0 or less.

### DETAILED DESCRIPTION OF THE INVENTION

Reducing scratches using conventional polishing compositions is not sufficient for realizing a further increase in the capacity of magnetic disk drives, and it is necessary to further reduce nanoprotrusion defects on the substrate surface after polishing in addition to the scratches.

Further, with the increase in capacity, the recording system of magnetic disks has shifted from the horizontal magnetic recording system to the perpendicular magnetic recording system. The production process of magnetic disks for the perpendicular magnetic recording system does not require a texturing step, which is needed to align the magnetization direction for the horizontal magnetic recording system, and a magnetic layer is formed directly upon the surface of the substrate after polishing. Accordingly, the properties required for the surface quality of substrates have become even more stringent. Conventional polishing compositions cannot achieve a reduction of nanoprotrusion defects and scratches to a satisfactory degree demanded of the surface of a substrate for the perpendicular magnetic recording system.

With the foregoing in mind, the present invention provides a polishing composition for a magnetic disk substrate, with which a reduction of scratches and nanoprotrusion defects on the substrate surface after polishing can be achieved. The present invention also provides a polishing method and a method for producing a magnetic disk substrate using the polishing composition.

With the polishing composition of the present invention, it is possible to produce a magnetic disk substrate, particularly a magnetic disk substrate for the perpendicular magnetic recording system and with reduced nanoprotrusion defects as well as scratches on the surface of the Ni—P-plated aluminum alloy substrate after polishing.

[Nanoprotrusion Defects]

As used herein, a “nanoprotrusion defect” refers to a defect on the substrate surface after polishing in the manufacturing process of a magnetic disk substrate, and is an optically detectable protrusion defect having a size of about less than 10 nm. To realize a magnetic disk having a higher density and a larger capacity it is necessary that the space between the magnetic head and the magnetic disk is less than 10 nm. Accordingly, any remaining nanoprotrusions may result in the wearing of the magnetic head, and a decreased recording density and the instability of the magnetic disk drive. If nanoprotrusion defects on the substrate surface after polishing can be reduced, then it is possible to decrease the flying height of the magnetic head, thus making it possible to improve the recording density of the magnetic disk substrate.

[Scratches]

As used herein, a “scratch” refers to a minute flaw having a depth of 1 nm or more, a width of 100 nm or more, and a length of 1000 nm or more in a substrate surface. A “scratch” can be detected, for example, by Candela 6100 series manufactured by KLA-Tencor Corporation or NS1500 series manufactured by Hitachi High-Technologies Corporation, which are optical defect detection apparatuses, and can be quantitatively evaluated as the number of scratches. Furthermore, the size and the shape of a detected scratch can be analyzed using an atomic force microscope (AFM), a scanning electron microscope (SEM), and a transmission electron microscope (TEM).

[Ni—P-Plated Aluminum Alloy Substrate]

As used herein, an “Ni—P-plated aluminum alloy substrate” refers to a substrate obtained by grinding the surface of an aluminum alloy plate for a magnetic disk substrate and then electrolessly plating the aluminum alloy plate with Ni—P. A magnetic disk substrate can be produced by polishing the surface of the Ni—P-plated aluminum alloy substrate and forming a magnetic film on the surface of the substrate by sputtering or the like.

The present invention is based upon the findings that use of a polishing composition containing a combination of a heterocyclic aromatic compound including two or more nitrogen atoms in its ring structure and an aliphatic amine compound or alicyclic amine compound including two to four nitrogen atoms in its molecules and having a pH of 3.0 or less in polishing a Ni—P-plated aluminum alloy substrate can result in not only a reduction of scratches but also a reduction of nanoprotrusion defects on the substrate surface after polishing, thereby allowing the production of a magnetic disk substrates that are adaptive to the demand for an increase in the recording capacity.

As one of the effects resulting from adding azoles such as BTA to a polishing composition, a reduction of scratches has been conventionally known. In addition to that, it is also found that a combination of the azoles and the aliphatic amine compound or alicyclic amine compound not only promotes a reduction of scratches but also significantly reduces nanoprotrusion defects. Although JP 2001-089747 A and JP 2004-311484 A disclose polishing compositions containing BTA and ethylenediamine, these polishing compositions are for CMP processing of a semiconductor device having a copper film, a bather layer of a tantalum compound and an insulating layer of SiO₂, and they are not for polishing the surface of a Ni—P-plated aluminum alloy substrate. Further, although JP 2001-089747 A and JP 2004-311484 A show that the polishing compositions are effective in suppressing dishing and erosion, they are silent as to whether the compositions are effective in reducing nanoprotrusion defects.

That is, viewed from one aspect, the present invention relates to a polishing composition for a Ni—P-plated aluminum alloy substrate (hereinafter also referred to as the “polishing composition of the present invention”). The polishing composition contains an abrasive, an acid, an oxidizing agent, a heterocyclic aromatic compound, an aliphatic amine compound or alicyclic amine compound, and water, the heterocyclic aromatic compound includes two or more nitrogen atoms in its ring structure, the aliphatic amine compound or alicyclic amine compound includes two to four nitrogen atoms in its molecules, and the polishing composition has a pH of 3.0 or less.

With the polishing composition of the present invention, it is possible to produce a magnetic disk substrate, particularly a magnetic disk substrate for the perpendicular magnetic recording system where nanoprotrusion defects as well as scratches on the surface of the Ni—P-plated aluminum alloy substrate after polishing are reduced.

Although details on the mechanism why the polishing composition of the present invention can reduce not only scratches but also nanoprotrusion defects are not clear, the following may be assumed.

Since there are Ni-microcrystal portions in some parts of the Ni—P plating layer, a heterocyclic aromatic compound such as BTA is believed to attach to the Ni-microcrystal portions and form a protective film thereon, thereby contributing to the reduction of scratches. On the other hand, it is believed that an aliphatic amine compound or alicyclic compound amine, such as diamine, triamine or tetraamine, hardy attaches to the Ni-microcrystal portions in the Ni—P plating layer but attaches to portions in the Ni—P plating layer with an amorphous structure and forms a protective layer thereon.

Thus, it can be assumed that as a result of using the polishing composition of the present invention containing a combination of a heterocyclic aromatic compound, such as BTA, and an aliphatic amine compound or alicyclic amine compound, such as diamine, and having a pH of 3.0 or less, a protective layer is formed entirely on the Ni—P-plated aluminum alloy substrate, thereby further reducing scratches as well as nanoprotrusion defects on the substrate surface after polishing. Nevertheless, the present invention is not limited to this mechanism.

[Heterocyclic Aromatic Compound]

The polishing composition of the present invention contains a heterocyclic aromatic compound. From the viewpoint of reducing scratches and nanoprotrusion defects on the substrate surface after polishing, the heterocyclic aromatic compound contained in the polishing composition of the present invention is preferably a heterocyclic aromatic compound including two or more, preferably three or more, more preferably three to nine, still more preferably three to five, and even more preferably three or four nitrogen atoms in its ring structure.

From the viewpoint of reducing scratches and nanoprotrusion defects on the substrate surface after polishing, the heterocyclic aromatic compound contained in the polishing composition of the present invention is preferably a protonated heterocyclic aromatic compound having a small pKa value, in other words, a heterocyclic aromatic compound with strong electrophilicity. Specifically, the heterocyclic aromatic compound has a pKa value of preferably −3 to 4, more preferably −3 to 3, and still more preferably −3 to 2.5. Preferred examples of heterocyclic aromatic compounds including two or more nitrogen atoms in their ring structures include pyrazine, pyridazine, 1,2,3-triazine, 1,2,4-triazine, 1,2,5-triazine, 1,3,5-triazine, 1,2,4-oxadiazole, 1,2,5-oxadiazole, 1,3,4-oxadiazole, 1,2,5-thiadiazole, 1,3,4-thiadiazole, 3-aminopyrazole, 4-aminopyrazole, 3,5-dimethylpyrazole, pyrazole, 2-aminoimidazole, 4-aminoimidazole, 5-aminoimidazole, 2-methylimidazole, 2-ethylimidazole, imidazole, benzoimidazole, 1,2,3-triazole, 4-amino-1,2,3-triazole, 5-amino-1,2,3-triazole, 1,2,4-triazole, 3-amino-1,2,4-triazole, 5-amino-1,2,4-triazole, 3-mercapto-1,2,4-triazole, 1H-tetrazole, 5-aminotetrazole, 1H-benzotriazole, 1H-tolyltriazole, 2-aminobenzotriazole, 3-aminobenzotriazole and an alkyl-substituted or amine-substituted product thereof. 1H-tetrazole, 1H-benzotriazole and 1H-tolyltriazole are more preferable, 1H-tetrazole and 1H-benzotriazole are still more preferable, and 1H-benzotriazole is even more preferable. An exemplary alkyl group of the alkyl-substituted product described above includes a lower alkyl group having a carbon number of 1 to 4, more specifically a methyl group or an ethyl group. Examples of the amine-substituted product described above include 1-[N,N-bis(hydroxyethylene)aminomethyl]benzotriazole and 1-[N,N-bis(hydroxyethylene)aminomethyl]tolyltriazole. Descriptions of the pKa of a protonated heterocyclic aromatic compound can be found in Takao Sakamoto, Chemistry of Aromatic Heterocyclic Compound (Kodansha Scientific Publishing), for example.

From the viewpoint of reducing scratches and nanoprotrusion defects on the substrate surface after polishing, the proportion of the heterocyclic aromatic compound in the polishing composition of the present invention relative to the weight of the entire polishing composition is preferably in a range of 0.01 to 10 wt %, more preferably 0.01 to 5 wt %, still more preferably 0.02 to 5 wt %, even more preferably 0.05 to 5 wt %, still even more preferably 0.08 to 2 wt %, still even more preferably 0.08 to 1 wt %, still even more preferably 0.1 to 1 wt %, still even more preferably 0.1 to 0.5 wt %, and still even more preferably 0.1 to 0.2 wt %. Note that the polishing composition may contain one heterocyclic aromatic compound, or may contain two or more heterocyclic aromatic compounds.

From the viewpoint of reducing scratches and nanoprotrusion defects on the substrate surface after polishing, the concentration ratio of the abrasive to the heterocyclic aromatic compound [Concentration of Abrasive (wt %)/Concentration of Heterocyclic Aromatic Compound (wt %)] in the polishing composition is preferably in a range of 0.1 to 2,000, more preferably 1 to 1,000, still more preferably 2 to 100, even more preferably 5 to 100, still even more preferably 10 to 80, and still even more preferably 20 to 70.

[Aliphatic Amine Compound or Alicyclic Amine Compound]

The polishing composition of the present invention contains an aliphatic amine compound or alicyclic amine compound. From the viewpoint of reducing scratches and nanoprotrusion defects on the substrate surface after polishing, the aliphatic amine compound or alicyclic amine compound contained in the polishing composition of the present invention includes two or more nitrogen atoms in its molecules. Further, from the viewpoint of maintaining the polishing rate, the aliphatic amine compound or alicyclic amine compound includes four or less, preferably three or less, and more preferably two or less nitrogen atoms in its molecules. Thus, from the viewpoints of maintaining the polishing rate and reducing scratches and nanoprotrusion defects, the aliphatic amine compound or alicyclic amine compound includes two to four, preferably two to three and more preferably two nitrogen atoms in its molecules.

From the viewpoint of reducing scratches and nanoprotrusion defects on the substrate surface after polishing, the aliphatic amine compound used in the polishing composition of the present invention is preferably selected from the group consisting of ethylenediamine, N,N,N′,N′-tetramethylethylenediamine, 1,2-diaminopropane, 1,3-diaminopropane, 1,4-diaminobutane, hexamethylenediamine, 3-(diethylamino)propylamine, 3-(dibutylamino)propylamine, 3-(methylamino)propylamine, 3-(dimethylamino)propylamine, N-aminoethylethanolamine, N-aminoethylisopropanolamine, N-aminoethyl-N-methylethanolamine, diethylenetriamine, and triethylenetetraamine. Furthermore, from the viewpoints of reducing an amine smell and improving the solubility in water, the aliphatic amine compound is more preferably selected from the group consisting of N-aminoethylethanolamine, N-aminoethylisopropanolamine and N-aminoethyl-N-methylethanolamine, and still more preferably is N-aminoethylethanolamine.

From the viewpoint of reducing scratches and nanoprotrusion defects on the substrate surface after polishing, the alicyclic amine compound used in the polishing composition of the present invention is selected preferably from the group consisting of piperazine, 2-methylpiperazine, 2,5-dimethylpiperazine, 1-amino-4-methylpiperzine, N-methylpiperzine, N-(2-aminoethyl)piperazine and hydroxyethylpiperazine, more preferably from the group consisting of piperazine, 2-methylpiperazine, 2,5-dimethylpiperazine, N-methylpiperzine, N-(2-aminoethyl)piperazine and hydroxyethylpiperazine, still more preferably from the group consisting of piperazine, N42-aminoethyl)piperazine and hydroxyethylpiperazine, and even more preferably from the group consisting of N-(2-aminoethyl)piperazine and hydroxyethylpiperazine.

Therefore, from the viewpoints of reducing scratches and nanoprotrusion defects on the substrate surface after polishing, reducing an amine smell, and improving the solubility in water, the aliphatic amine compound or alicyclic amine compound used in the polishing composition of the present invention is still more preferably selected from the group consisting of N-aminoethylethanolamine, N-aminoethylisopropanolamine, N-aminoethyl-N-methylethanolamine, piperazine, N-(2-aminoethyl)piperazine and hydroxyethylpiperazine, even more preferably from the group consisting of N-aminoethylethanolamine, N-(2-aminoethyl)piperazine and hydroxyethylpiperazine, and is still even more preferably N-aminoethylethanolamine.

From the viewpoint of reducing scratches and nanoprotrusion defects on the substrate surface after polishing, the proportion of the aliphatic amine compound or alicyclic amine compound in the polishing composition of the present invention relative to the weight of the entire polishing composition is preferably in a range of 0.001 to 10 wt %, more preferably 0.01 to 5 wt %, still more preferably 0.01 to 0.5 wt %, even more preferably 0.02 to 0.2 wt %, still even more preferably 0.03 to 0.1 wt %, and still even more preferably 0.03 to 0.06 wt %. Note that the polishing composition may contain one aliphatic or alicyclic amine compound, or may contain two or more aliphatic or alicyclic amine compounds.

From the viewpoint of reducing scratches and nanoprotrusion defects on the substrate surface after polishing, the concentration ratio of the abrasive to the aliphatic amine compound or alicyclic amine compound [Concentration of Abrasive (wt %)/Concentration of Aliphatic Amine Compound or Alicyclic Amine Compound (wt %)] in the polishing composition is preferably in a range of 0.5 to 20,000, more preferably 1 to 1,000, still more preferably 5 to 500, even more preferably 10 to 250, still even more preferably 25 to 200, still even more preferably 40 to 180, and still even more preferably 75 to 150.

From the viewpoint of reducing scratches and nanoprotrusion defects on the substrate surface after polishing, the concentration ratio of the heterocyclic aromatic compound to the aliphatic amine compound or alicyclic amine compound [Concentration of Heterocyclic Aromatic Compound (wt %)/Concentration of Aliphatic Amine Compound or Alicyclic Amine Compound (wt %)] in the polishing composition is preferably in a range of 0.01 to 2,000, more preferably 0.1 to 200, still more preferably 0.1 to 50, even more preferably 0.5 to 25, still even more preferably 1 to 25, still even more preferably 1 to 7, and still even more preferably 1.5 to 5.

[Abrasive]

The polishing composition of the present invention contains an abrasive. As the abrasive used in the present invention, it is possible to use an abrasive commonly used for polishing, and examples thereof include metals, carbides, nitrides, oxides or borides of metals or metalloids, and diamond. Metal or metalloid elements are those belonging to Group 2A, 2B, 3A, 3B, 4A, 4B, 5A, 6A, 7A or 8 in the periodic table (long period form). Specific examples of the abrasive include aluminum oxide (alumina), silicon carbide, diamond, magnesium oxide, zinc oxide, titanium oxide, cerium oxide, zirconium oxide, and silica. From the viewpoint of increasing the polishing rate, it is preferable to use one or more of these. Among these, alumina and colloidal silica are preferable from the viewpoint of reducing scratches and nanoprotrusion defects on the substrate surface after polishing. Colloidal silica is more preferable. A preferred embodiment of colloidal silica will be described later.

From the viewpoint of increasing the polishing rate, the proportion of the abrasive relative to the polishing composition is preferably 0.5 wt % or more, more preferably 1 wt % or more, still more preferably 3 wt % or more, and even more preferably 4 wt % or more. Further, from the viewpoint of reducing scratches and nanoprotrusion defects on the substrate surface after polishing, the proportion of the abrasive is preferably 20 wt % or less, more preferably 15 wt % or less, still more preferably 13 wt % or less, even more preferably 10 wt % or less, and still even more preferably 7 wt % or less. That is, the proportion of the abrasive is preferably in a range of 0.5 to 20 wt %, more preferably 1 to 15 wt %, still more preferably 3 to 13 wt %, even more preferably 4 to 10 wt % and still even more preferably 4 to 7 wt %.

[Acid]

The polishing composition of the present invention contains an acid. As used herein, the use of an acid means use of an acid and/or salt thereof. From the viewpoint of increasing the polishing rate, the acid used in the polishing composition of the present invention is preferably an acidic compound having a pK1 of 2 or less, preferably a compound having a pK1 of 1.5 or less, more preferably a compound having a pK1 of 1 or less, still more preferably a compound exhibiting acidity that is so strong that cannot be expressed by pK1, from the viewpoint of reducing scratches and nanoprotrusion defects on the substrate surface. Preferable acids include: inorganic acids such as nitric acid, sulfuric acid, sulfurous acid, persulfuric acid, hydrochloric acid, perchloric acid, phosphoric acid, phosphonic acid, phosphinic acid, pyrophosphoric acid, tripolyphosphoric acid, and amidosulfuric acid; organic phosphonic acids such as 2-aminoethylphosphonic acid, 1-hydroxyethylidene-1,1-diphosphonic acid, aminotri(methylenephosphonic acid), ethylenediaminetetra(methylenephosphonic acid), diethylenetriaminepenta(methylenephosphonic acid), ethane-1,1,-diphosphonic acid, ethane-1,1,2-triphosphoric acid, ethane-1-hydroxy-1,1-diphosphonic acid, ethane-1-hydroxy-1,1,2-triphosphonic acid, ethane-1,2-dicarboxy-1,2-diphosphonic acid, methanehydroxyphosphonic acid, 2-phosphonobutane-1,2-dicarboxylic acid, 1-phosphonobutane-2,3,4-tricarboxylic acid, and α-methyl phosphonosuccinic acid; aminocarboxylic acids such as glutamic acid, picolinic acid, and asp artic acid; and carboxylic acids such as citric acid, tartaric acid, oxalic acid, nitroacetic acid, maleic acid, and oxalacetic acid. Among these, from the viewpoint of reducing scratches, inorganic acids, carboxylic acids, and organic phosphonic acids are preferable and inorganic acids and organic phosphonic acids are more preferable from the viewpoint of improving the stability of the oxidizing agent and the disposability of liquid wastes. Among inorganic acids, nitric acid, sulfuric acid, hydrochloric acid, and perchloric acid are more preferable, and sulfuric acid is still more preferable. Among organic phosphonic acids, 1-hydroxyethylidene-1,1-diphosphonic acid, aminotri(methylenephosphonic acid), ethylenediaminetetra(methylenephosphonic acid), and diethylenetriaminepentdmethylenephosphonic acid) and salts thereof are more preferable, and 1-hydroxyethylidene-1,1-diphosphonic acid and aminotri(methylenephosphonic acid) are still more preferable. Although these acids and salts thereof may be used alone or in combination of two or more, it is preferable to use them in combination of two or more, from the viewpoints of increasing the polishing rate, reducing nanoprotrusions, and improving the cleanliness of the substrate. It is more preferable to use sulfuric acid and 1-hydroxyethylidene-1,1-diphosphonic acid in combination from the viewpoints of reducing nanoprotrusions and scratches and improving the stability of the oxidizing agent and the disposability of liquid wastes. Here, pK1 is the logarithmic value of the reciprocal of a first acid dissociation constant (25° C.) of an organic compound or an inorganic compound. The pK1s of various compounds are described, for example, in the Chemical Society of Japan eds., Kagakubinran (Handbook of Chemistry) (Basic) II (4th revised edition, pp. 316-325).

There is no particular limitation to the counter ion in the case of using salts of these acids, and specific examples thereof include ions of metals, ammonium, and alkyl ammonium. Specific examples of the above-mentioned metals include metals belonging to Group 1A, 1B, 2A, 2B, 3A, 3B, 4A, 6A, 7A, or 8 in the periodic table (long period form). Among these, from the viewpoint of reducing scratches and nanoprotrusion defects on the substrate surface after polishing, salts with metals belonging to Group 1A or salts with ammonium are preferable.

From the viewpoints of increasing the polishing rate and reducing scratches and nanoprotrusion defects on the substrate surface after polishing, the proportion of the acid or salt thereof relative to the polishing composition is preferably in a range of 0.001 to 5 wt %, more preferably 0.01 to 4 wt %, still more preferably 0.05 to 3 wt %, even more preferably 0.1 to 2 wt %, and still even more preferably 0.2 to 1 wt %.

[Oxidizing Agent]

The polishing composition of the present invention contains an oxidizing agent. From the viewpoints of increasing the polishing rate and reducing scratches and nanoprotrusion defects on the substrate surface after polishing, examples of the oxidizing agents that can be used in the polishing composition of the present invention include peroxides, permanganic acid or salts thereof, chromic acid or salts thereof, peroxoacid or salts thereof, oxoacid or salts thereof, metal salts, nitric acids, and sulfuric adds.

Example of the peroxides include hydrogen peroxide, sodium peroxide, and barium peroxide, examples of permanganic acid or salts thereof include potassium permanganate, examples of chromic acid or salts thereof include metal chromate and metal dichromate, examples of peroxoacid or salts thereof include peroxodisulfuric acid, ammonium peroxodisulfate, metal peroxodisulfate, peroxophosphoric acid, peroxosulfuric acid, sodium peroxoborate, performic acid, peracetic acid, perbenzoic acid, and perphthalic acid, examples of oxoacid or salts thereof include hypochlorous acid, hypobromous acid, hypoiodous acid, chloric acid, bromic acid, iodic acid, sodium hypochlorite, and calcium hypochlorite, and examples of metal salts include iron(III) chloride, iron(III) nitrate, iron(III) sulfate, iron(III) citrate, and ammonium iron(III) sulfate.

From the viewpoint of reducing scratches and nanoprotrusion defects on the substrate surface after polishing, examples of preferable oxidizing agents include hydrogen peroxide, iron(III) nitrate, peracetic acid, ammonium peroxodisulfate, iron(III) sulfate, and ammonium iron(III) sulfate. More preferable oxidizing agents include hydrogen peroxide in that it prevents metal ions from being attached to its surface, can be used for a wide variety of uses, and is inexpensive. These oxidizing agents may be used alone or in combination of two or more.

From the viewpoint of increasing the polishing rate, the proportion of the oxidizing agent relative to the polishing composition is preferably 0.01 wt % or more, more preferably 0.05 wt % or more, still more preferably 0.1 wt % or more, even more preferably 0.2 wt % or more, and particularly preferably 0.3 wt % or more. Further, from the viewpoint of reducing scratches and nanoprotrusion defects on the substrate surface after polishing, the proportion of the oxidizing agent is preferably 4 wt % or less, more preferably 2 wt % or less, still more preferably 1 wt % or less, even more preferably 0.8 wt % or less, and particularly preferably 0.6 wt % or less. Accordingly, in order to increase the polishing rate while maintaining the surface quality, the proportion of the oxidizing agent is preferably in a range of 0.01 to 4 wt %, more preferably 0.05 to 2 wt %, still more preferably 0.1 to 1 wt %, even more preferably 0.2 to 0.8 wt %, and particularly preferably 0.3 to 0.6 wt %.

[Water]

The water in the polishing composition of the present invention is used as a medium, and examples thereof include distilled water, ion exchanged water, and ultrapure water. From the viewpoint of the surface cleanliness of a substrate to be polished, ion exchanged water and ultrapure water are preferable, and ultrapure water is more preferable. The proportion of the water relative to the polishing composition is preferably in a range of 67.0 to 99.5 wt %, more preferably 76.5 to 98.9 wt %, still more preferably 81.6 to 96.8 wt %, even more preferably 86.5 to 95.6 wt %, and particularly preferably 91.1 to 95.4 wt %.

[Water-soluble Polymer having Anionic Group]

From the viewpoint of reducing scratches and nanoprotrusion defects on the substrate surface after polishing, the polishing composition of the present invention preferably contains a water-soluble polymer having an anionic group (hereinafter also referred to as an anionic polymer). It can be assumed that the polymer reduces frictional oscillations during polishing and prevents silica agglomerates from falling off from an opening of a polishing pad, thereby reducing scratches and nanoprotrusion defects on the substrate surface after polishing.

Examples of the anionic group in the anionic polymer include a carboxylic acid group, a sulfonic add group, a sulfuric ester group, a phosphoric ester group and a phosphoric acid group. These anionic groups may be in the form of neutralized salt. From the viewpoint of reducing scratches and nanoprotrusions, an anionic polymer having at least one of a sulfonic acid group and a carboxylic acid group is preferable, and an anionic polymer having a sulfonic acid group is more preferable. It is assumed that the polymer adheres to a polishing pad and reduces frictional oscillations during polishing, so that silica agglomerates are prevented from falling off from an opening of the polishing pad. And as a result of the synergy between the anionic polymer and the above-described heterocyclic aromatic compound, scratches and nanoprotrusion defects on the substrate surface after polishing are reduced significantly. The present invention is not limited to these assumed mechanisms, however.

As used herein, a “sulfonic acid group” refers to a sulfonic acid group or salt thereof and a “carboxylic acid group” refers to a carboxylic acid group or salt thereof. There is no particular limitation when these groups form salts, and specific examples thereof include salts with metals, salts with ammonium, and salts with alkyl ammonium. Specific examples of the metals include metals belonging to Group 1A, 1B, 2A, 2B, 3A, 3B, 4A, 6A, 7A, or 8 in the periodic table (long period form). Among these, from the viewpoint of reducing nanoscratches, metals belonging to Group 1A, 3B or 8 are preferable and sodium and potassium belonging to Group 1A are more preferable. Specific examples of alkyl ammonium include tetramethylammonium, tetraethylammonium and tetrabutylammonium. Among these, ammonium salt, sodium salt and potassium salt are more preferable.

The anionic polymer having at least one of a sulfonic acid group and a carboxylic acid group of the present invention is preferably obtained by polymerizing monomers having an ionic hydrophilic group, such as a monomer having a sulfonic acid group and a monomer having a carboxylic acid group. Any of random, block and graft polymerization may be used to polymerize these monomers.

Examples of monomers having a sulfonic acid group include isoprene sulfonic acid, 2-(meth)acrylamide-2-methylpropanesulfonic acid, styrene sulfonic acid, methallyl sulfonic acid, vinyl sulfonic acid, aryl sulfonic acid, isoamylene sulfonic acid, and naphthalene sulfonic acid. Examples of monomers having a carboxylic group include itaconic acid, (meth)acrylic acid and maleic acid.

Monomers other than those described above may also be used as the anionic polymer having at least one of a sulfonic acid group and a carboxylic acid group. Examples of other monomers that can be used as the anionic polymer include: aromatic vinyl compounds such as styrene, α-methylstryrene, vinyltoluene and p-methylstryrene; alkyl (meth)acrylates such as methyl (meth)acrylate, ethyl (meth)acrylate and octyl (meth)acrylate; aliphatic conjugated dienes such as butadiene, isoprene, 2-chlor-1,3-butadine, and 1-chlor-1,3-butadiene; vinyl cyanide compounds such as (meth)acrylonitrile; and sulfonic acid compounds such as vinyl sulfonic acid, methacroyloxymethyl phosphoric acid, methacroyloxymethyl phosphoric acid, methacroyloxybutyl phosphoric acid, methacroyloxyhexyl phosphoric acid, methacroyloxyoctyl phosphoric acid, methacroyloxydecyl phosphoric acid, methacroyloxylauryl phosphoric acid, methacroyloxystearyl phosphoric acid, and methacroyloxyl, 4-dimethylcyclohexyl phosphoric acid. These monomers may be used alone or in combination of two or more.

From the viewpoint of reducing scratches and nanoprotrusion defects on the substrate surface after polishing, specific examples of preferable anionic polymers having at least one of a sulfonic acid group and a carboxylic acid group include polyacrylic acid, a copolymer of (meth)acrylic acid and isoprenesulfonic acid, a copolymer of (meth)acrylic acid and 2-(meth)acrylamide-2-methylpropanesulfonic acid, a copolymer of (meth)acrylic acid, isoprenesulfonic acid and 2-(meth)acrylamide-2-methylpropanesulfonic acid, a copolymer of (meth)acrylic acid and maleic acid, formalin condensate of styrene sulfonic acid, a copolymer of styrene and isoprenesulfonic acid and a copolymer having one or more of the constitutional units expressed by the following general formulas (1) and (2) and the constitutional unit expressed by the following general formula (3). From the similar viewpoint, polyacrylic acid, a copolymer of (meth)acrylic acid and 2-(meth)acrylamide-2-methylpropanesulfonic acid, formalin condensate of styrene sulfonic acid, formalin condensate of naphthalenesulfonic acid, a copolymer of styrene and isoprenesulfonic acid, and a copolymer having one or more of the constitutional units expressed by the general formulas (1) and (2) and the constitutional unit expressed by the general formula (3) are more preferable, and a copolymer having the constitutional unit expressed by the general formula (1) and the constitutional unit expressed by the general formula (3) is still more preferable.

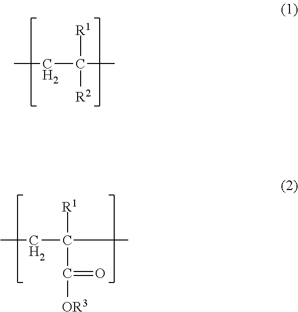

From the viewpoints of increasing the amount of adherence of the copolymer to the polishing pad and reducing scratches and nanoprotrusion defects on the substrate surface after polishing, R¹ in the general formulas (1) and (2) is a hydrogen atom or an alkyl group having a carbon number of 1 to 4, preferably a hydrogen atom or an alkyl group having a carbon number of 1 to 3, more preferably a hydrogen atom, a methyl group or an ethyl group, and still more preferably a hydrogen atom or a methyl group. From the viewpoints of increasing the amount of adherence of the copolymer to the polishing pad and reducing scratches and nanoprotrusion defects on the substrate surface after polishing, R² in the general formula (1) is an aryl group or an aryl group for which one or more alkyl groups having a carbon number of 1 to 4 may substitute, preferably a phenyl group or a phenyl group for which one or more alkyl groups having a carbon number of 1 to 4 may substitute, and more preferably a phenyl group. The alkyl group having a carbon number of 1 to 4 may have a straight-chain or branched-chain structure. From the viewpoints of increasing the amount of adherence of the copolymer to the polishing pad and reducing scratches and nanoprotrusion defects on the substrate surface after polishing, R³ in the general formula (2) is preferably a hydrogen atom, an alkali metal atom, an alkali earth metal atom (½ atom), ammonium or organic ammonium or a hydrocarbon chain having a carbon number of 1 to 22. The hydrocarbon chain has a carbon number of preferably 1 to 18, more preferably 1 to 12, still more preferably 1 to 8, and even more preferably 1 to 4. Further, the hydrocarbon chain may have a straight-chain or branched-chain structure. As the hydrocarbon chain, an alkyl group and an alkenyl group are preferable, and an alkyl group is more preferable. Further, the copolymer may contain two or more hydrophobic constitutional units.

From the viewpoint of reducing scratches and nanoprotrusion defects on the substrate surface after polishing, the proportion of the constitutional units expressed by the general formulas (1) and (2) relative to the entire constitutional units forming the copolymer is preferably in a range of 5 to 95 mol %, more preferably 5 to 70 mol %, still more preferably 10 to 60 mol %, even more preferably 15 to 50 mol %, and still even more preferably 20 to 40 mol %.

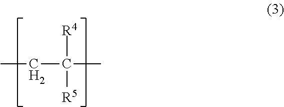

From the viewpoint of reducing scratches and nanoprotrusion defects on the substrate surface after polishing, R⁴ in the general formula (3) is a hydrogen atom or an alkyl group having a carbon number of 1 to 4, preferably a hydrogen atom or an alkyl group having a carbon number of 1 to 3, more preferably a hydrogen atom, a methyl group or an ethyl group, still more preferably a hydrogen group or a methyl group, and even more preferably a methyl group. From the viewpoints of improving the solubility of the anionic polymer in the polishing composition and reducing scratches and nanoprotrusion defects on the substrate surface after polishing, R⁵ in the general formula (3) is an aryl group having one or more sulfonic acid groups, preferably a phenyl group having one or more sulfonic acid groups, more preferably a phenyl group having one sulfonic acid group at an ortho, meth or para position, and still more preferably a phenyl group having a sulfonic acid group at a para position. The anionic polymer having at least one of a sulfonic acid group and a carboxylic acid group may include two or more constitutional units having a sulfonic acid group.

From the viewpoint of reducing scratches and nanoprotrusion defects on the substrate surface after polishing, the proportion of the constitutional unit expressed by the general formula (3) relative to the entire constitutional units forming the copolymer is preferably in a range of 5 to 95 mol %, more preferably 40 to 90 mol %, still more preferably 50 to 85 mol %, and even more preferably 60 to 80 mol %.

From the viewpoint of reducing scratches and nanoprotrusion defects on the substrate surface after polishing, the proportion of total of the constitutional units expressed by the general formulas (1), (2) and (3) relative to the entire constitutional units forming the anionic polymer having at least one of a sulfonic acid group and a carboxylic acid group is preferably in a range of 70 to 100 mol %, more preferably 80 to 100 mol %, still more preferably 90 to 100 mol % and even more preferably 95 to 100 mol %.

From the viewpoint of reducing substrate surface waviness and nanoprotrusion defects after polishing, the molar ratio of the constitutional units expressed by the general formulas (1) and (2) to the constitutional unit expressed by the general formula (3) [mol % of Constitutional Units Expressed by General Formulas (1) and (2)/mol % of Constitutional Unit Expressed by General Formula (3)] within the entire constitutional units forming the copolymer is preferably in a range of 5/95 to 95/5, more preferably 10/90 to 60/40, still more preferably 15/85 to 50/50, and even more preferably 20/80 to 40/60.

When the anionic polymer having at least one of a sulfonic acid group and a carboxylic acid group is a copolymer of (meth)acrylic acid and 2-(meth)acrylamide-2-methylpropanesulfonic acid, from the viewpoint of reducing scratches and nanoprotrusion defects on the substrate surface after polishing, the molar ratio in polymerization of (meth)acrylic acid to 2-(meth)acrylamide-2-methylpropanesulfonic acid [(meth)acrylic acid/2-(meth)acrylamide-2-methylpropanesulfonic acid] is preferably in a range of 95/5 to 40/60, more preferably 95/5 to 50/50, still more preferably 95/5 to 60/40, even more preferably 95/5 to 70/30, still even more preferably 95/5 to 75/25, still even more preferably 95/5 to 80/20, still even more preferably 95/5 to 85/15, and still even more preferably 90/10.

[Weight-Average Molecular Weight of Anionic Polymer]

From the viewpoint of reducing scratches and nanoprotrusion defects on the substrate surface after polishing, the weight-average molecular weight of the anionic polymer having at least one of a sulfonic acid group and a carboxylic acid group is preferably 500 to 120,000, more preferably 1,000 to 100,000, still more preferably 1,000 to 30,000, even more preferably 1,000 to 10,000, and still even more preferably 1,500 to 8,000. When the anionic polymer having at least one of a sulfonic acid group and a carboxylic acid group is a copolymer of (meth)acrylic acid and 2-(meth)acrylamide-2-methylpropanesulfonic acid, the weight-average molecular weight of the copolymer is preferably 500 to 120,000, more preferably 500 to 100,000, still more preferably 500 to 30,000, even more preferably 500 to 10,000, still even more preferably 500 to 8,000, still even more preferably 500 to 5,000, still even more preferably 500 to 4,500, still even more preferably 500 to 4,000, still even more preferably 500 to 3,500, still even more preferably 500 to 3,000, still even more preferably 1,000 to 3,000, still even more preferably 1,500 to 2,500 and still even more preferably 2,000, from the viewpoint similar to the above-described. The weight-average molecular weight is a value measured by the method described in Examples using gel permeation chromatography (GPC).

When the anionic polymer having at least one of a sulfonic acid group and a carboxylic acid group is at least partially forming salt, there is no particular limitation to the counter ion. Similarly to the above-described hydrophilic constitutional units, examples of the counter ion include salts with metals, salts with ammonium, and salts with alkyl ammonium.

From the viewpoint of reducing scratches and nanoprotrusion defects on the substrate surface after polishing, the proportion of the anionic polymer having at least one of a sulfonic acid group and a carboxylic acid group relative to the polishing composition is preferably in a range of 0.001 to 1 wt %, more preferably 0.005 to 0.5 wt %, still more preferably 0.01 to O₂ wt %, even more preferably 0.01 to 0.1 wt %, still even more preferably 0.015 to 0.075 wt %, and still even more preferably 0.02 to 0.075 wt %.

Further, from the viewpoint of reducing scratches and nanoprotrusion defects on the substrate surface after polishing, the concentration ratio of the abrasive to the anionic polymer [Concentration of Abrasive (wt %)/Concentration of Anionic Polymer (wt %)] in the polishing composition is preferably in a range of 0.5 to 20,000, more preferably 1 to 5,000, still more preferably 5 to 5,000, even more preferably 10 to 1,000, still even more preferably 20 to 750, still even more preferably 25 to 500, and still even more preferably 50 to 500.

Further, from the viewpoint of reducing scratches and nanoprotrusion defects on the substrate surface after polishing, the concentration ratio of the heterocyclic aromatic compound to the anionic polymer [Concentration of Heterocyclic Aromatic Compound (wt %)/Concentration of Anionic Polymer (wt %)] in the polishing composition is preferably in a range of 0.01 to 2,000, more preferably 0.05 to 200, still more preferably 0.1 to 100, even more preferably 0.5 to 100, still even more preferably 1 to 75, still even more preferably 1 to 50, and particularly preferably 1 to 20.

Further, from the viewpoint of reducing scratches and nanoprotrusion defects on the substrate surface after polishing, the concentration ratio of the aliphatic amine compound or alicyclic amine compound to the anionic polymer [Concentration of Aliphatic Amine Compound or Alicyclic Amine Compound (wt %)/Concentration of Anionic Polymer (wt %)] in the polishing composition is preferably in a range of 0.01 to 100, more preferably 0.1 to 50, still more preferably 0.1 to 10, even more preferably 0.5 to 10, still even more preferably 0.5 to 6, still even more preferably 0.6 to 3, and particularly preferably 0.6 to 1.5.

[Colloidal Silica]

An embodiment where silica particles are used as the abrasive will be described. Silica particles used in the polishing composition of the present invention may be of colloidal silica, fumed silica, or surface-modified silica. Nevertheless, colloidal silica is preferable from the viewpoint of reducing scratches and nanoprotrusion defects on the substrate surface after polishing. Colloidal silica may be used alone or in combination of two or more types.

From the viewpoint of reducing scratches and nanoprotrusion defects on the substrate surface after polishing, colloidal silica used as the abrasive preferably satisfies all of the three following conditions:

a) having a ΔCV value of 0 to 10%,

b) having a CV90 of 1 to 35%, and

c) having an average particle size based on a scattering intensity distribution of 1 to 40 nm.

[ΔCV Value]

As used herein, the ΔCV value of colloidal silica refers to the difference (ΔCV=CV30−CV90) between the values of coefficients of variation (CVs), i.e., CV30 and CV90, and is a value indicating the angular dependence of a scattering intensity distribution measured by dynamic light scattering. CV30 is obtained by dividing a particle size standard deviation measured based on a scattering intensity distribution at a detection angle of 30° (forward scattering) by dynamic light scattering by an average particle size measured based on a scattering intensity distribution at a detection angle of 30° by dynamic light scattering, and multiplying the result by 100. CV90 is obtained by dividing a particle size standard deviation measured based on a scattering intensity distribution at a detection angle of 90° (side scattering) by dynamic light scattering by an average particle size measured based on a scattering intensity distribution at a detection angle of 90° by dynamic light scattering, and multiplying the result by 100. Specifically, the ΔCV value can be measured by the method described in Examples.

There is a correlation between the ΔCV value of colloidal silica and the number of scratches. There also is a correlation between the ΔCV value of colloidal silica and the content of non-spherical silica Although the mechanism why adjusting the ΔCV value results in a reduction of scratches is not clear, it can be assumed as follows. Silica agglomerates (non-spherical silica) of 50 to 200 nm formed as a result of the agglomeration of primary colloidal silica particles are a cause for the occurrence of scratches. However, since the agglomerations are small in number, scratches are reduced.

That is, it seems that the presence of non-spherical particles in a particle dispersion sample, which have been difficult to detect conventionally, readily can be detected by focusing on the ΔCV value, and it is therefore possible to avoid using a polishing composition containing such non-spherical particles, thereby further reducing scratches.

Here, whether the particles contained in the particle dispersion sample are spherical or non-spherical is generally determined by a method in which the angular dependence of a diffusion coefficient (D=Γ/q²) measured by dynamic light scattering is used as an index (e.g., see JP H10-195152A). Specifically, the average shape of the particles contained in a dispersion is determined as being spherical if the angular dependence is small that is shown in a graph where Γ/q² is plotted against a scattering vector q², whereas the average shape of the particles contained in the dispersion is determined as being non-spherical if the angular dependence is large. In other words, this conventional method, in which the angular dependence of a diffusion coefficient measured by dynamic light scattering is used as an index, is a method by which the shape, the particle size, and the like of particles are detected and measured assuming that homogeneous particles are dispersed throughout the system. Therefore, it is difficult to detect non-spherical particles that are present in a dispersion sample in which spherical particles are dominant.

On the other hand, dynamic light scattering, in principle, can provide substantially constant results with regard to scattering intensity distributions regardless of the detection angle, when a spherical particle dispersion solution containing particles of 200 nm or less is measured, and the measurement results therefore are not dependent on the detection angle. However, due to the presence of non-spherical particles, the scattering intensity distribution obtained by dynamic light scattering of a spherical particle dispersion solution containing non-spherical particles significantly varies depending on the detection angle; the lower the detection angle, the broader the scattering intensity distribution. Consequently, the measurement results with regard to the scattering intensity distributions obtained by dynamic light scattering are dependent on the detection angle, and it is believed that a trace amount of non-spherical particles present in a spherical particle dispersion solution can be measured by measuring a ΔCV value, which is one of the indices for the “angular dependence of a scattering intensity distribution measured by dynamic light scattering.” However, the present invention is not limited to these mechanisms.

[Scattering Intensity Distribution]

As used herein, a “scattering intensity distribution” refers to a scattering intensity-based particle size distribution, which is among three types of particle size distribution (scattering intensity-based, volume-converted, number-converted) of submicron particles that are determined by dynamic light scattering (DLS) or quasi elastic light scattering (QLS). Normally, submicron particles undergo Brownian motion in a solvent, and the scattered light intensity thereof temporally varies (fluctuates) when the particles are irradiated with laser light. From this fluctuation of the scattered light intensity, an autocorrelation function is obtained, for example, by photon correlation (JIS Z 8826), a diffusion coefficient (D) representing the rate of the Brownian motion is then calculated by an analysis using the Cumulant method, and an average particle size (d; hydrodynamic diameter) can be obtained by the Einstein-Stokes equation. In addition to the polydispersity index (PI) obtained by the Cumulant method, the histogram method (Marquardt method), the inverse Laplace transform method (CONTIN method), the non-negative least square method (NNLS method) and the like may be used for the analysis of the particle size distribution.

Generally, the polydispersity index (PI) obtained by the Cumulant method is widely used for the analysis of the particle size distribution by dynamic light scattering. However, in a detection method that enables detection of a trace amount of non-spherical particles present in a particle dispersion, it is preferable to obtain an average particle size (d50) and a standard deviation from the analysis of the particle size distribution using the histogram method (Marquardt method) or the inverse Laplace transform method (CONTIN method), calculate a CV value (coefficient of variation: a numerical value obtained by dividing the standard deviation by the average particle size, and multiplying the result by 100), and use the resulting angular dependence (ΔCV value).

### (Reference Materials)

The 12th workshop on scattering (held on Nov. 22, 2000) textbook, 1. Basic course on scattering ‘Dynamic light scattering’ (Mitsuhiro Shibayama, the University of Tokyo)

The 20th workshop on scattering (held on Dec. 4, 2008) textbook, 5. Particle size distribution measurement of nanoparticles by dynamic light scattering (Yasuo Mori, Doshisha University)

[Angular Dependence of Scattering Intensity Distribution]

As used herein, “the angular dependence of the scattering intensity distribution of a particle dispersion” refers to the magnitude of variation of a scattering intensity distribution according to the scattered angle, when the scattering intensity distribution of the above-described particle dispersion is measured at different angles by dynamic light scattering. For example, if there is a large difference in scattering intensity distribution between a detection angle of 30° and a detection angle of 90°, then the angular dependence of the scattering intensity distribution of that particle dispersion can be regarded as large. Therefore, as used herein, the measurement of the angular dependence of a scattering intensity distribution also includes obtaining the difference (ΔCV value) between measured values that are based on scattering intensity distributions measured at two different detection angles.

As the combinations of two detection angles used for the measurement of the angular dependence of the scattering intensity distribution, a combination of a forward scattering detection angle and a side or back scattering detection angle is preferable, from the viewpoint of improving the accuracy of detecting non-spherical particles. From the similar viewpoint, the forward scattering detection angle is preferably 0 to 80°, more preferably 0 to 60°, still more preferably 10 to 50°, even more preferably 20 to 40°. From the similar viewpoint, the side or back scattering detection angle is preferably 80 to 180°, more preferably 85 to 175°. In the present invention, angles of 30° and 90° are used as the two detection angles for obtaining the ΔCV value.

From the viewpoint of reducing scratches and nanoprotrusion defects on the substrate surface after polishing, the ΔCV value of colloidal silica used in the present invention is preferably 0 to 10%, more preferably 0 to 9%, still more preferably 0 to 7%, and even more preferably 0 to 5%. Further, from the viewpoint of improving the productivity of the polishing composition, the ΔCV value is preferably 0.001% or more, and more preferably 0.01% or more. Accordingly, the ΔCV value is preferably 0 to 10%, more preferably 0.01 to 10%, still more preferably 0.01 to 9%, even more preferably 0.01 to 7%, and still even more preferably 0.01 to 5%.

[CV Value]

From the viewpoint of reducing scratches and nanoprotrusion defects on the substrate surface after polishing, the CV value (CV90) of colloidal silica used in the present invention is preferably 1 to 35%, more preferably 5 to 34%, and still more preferably 10 to 33%. As used herein, the CV value refers to the value of a coefficient of variation obtained by dividing a standard deviation based on a scattering intensity distribution by dynamic light scattering by an average particle size, and multiplying the result by 100. Particularly in this specification, the CV value measured at a detection angle of 90° (side scattering) is referred to as CV90, and the CV value at a detection angle of 30° (forward scattering) is referred to as CV30. Specifically, the CV values of colloidal silica can be obtained by the method described in Examples.

[Average Particle Size based on Scattering Intensity Distribution]

As used herein, “the average particle size of colloidal silica” refers to an average particle size based on a scattering intensity distribution measured at a detection angle of 90° by dynamic light scattering (hereinafter also referred to as an “average particle size based on a scattering intensity distribution”) unless otherwise specified. As will be described later, an average particle size (S2) measured by making observations with a transmission electron microscope may also be used. Specifically, the average particle size of colloidal silica can be obtained by the method described in Examples.

From the viewpoint of reducing scratches and nanoprotrusion defects on the substrate surface after polishing, the average particle size of colloidal silica based on a scattering intensity distribution is preferably 1 to 40 nm, more preferably 5 to 37 nm, and still more preferably 10 to 35 nm.

Examples of the method for adjusting the ΔCV value of colloidal silica include the following methods, which prevent generation of silica agglomerates (non-spherical silica) of 50 to 200 nm during preparation of the polishing composition.

A) A method based on filtration of the polishing composition

B) A method based on the process control during production of colloidal silica

In A) above, the ΔCV value can be reduced, for example, by removing silica agglomerates of 50 to 200 nm by centrifugal separation or filtration through a fine filter (see JP 2006-102829A and JP 2006-136996A). Specifically, the ΔCV value can be reduced by a method in which an appropriately diluted aqueous colloidal silica solution at a silica concentration of 20 wt % or less is centrifuged under the conditions determined by the Stokes equation and where 50 nm particles can be removed (e.g., 10,000 G or more, a height of approximately 10 cm in the centrifuge tube, 2 hours or more), a method in which pressure filtration is performed using a membrane filter with a pore diameter of 0.05 μm or 0.1 μm (for example, from Advantec Toyo Kaisha, Ltd, Sumitomo 3M Limited, and Millipore), and the like.

Colloidal silica particles are usually obtained by 1) placing a mixed solution (seed liquid) of less than 10 wt %, containing JIS No. 3 sodium silicate and seed particles (small-particle-size silica) into a reaction vessel and heating the solution to 60° C. or more; 2) adding dropwise thereto an aqueous acidic solution of active silica obtained by passing JIS No. 3 sodium silicate through a cation exchange resin and alkali (alkali metal or quaternary ammonium) to allow the growth of spherical particles, while maintaining the pH constant; and 3) aging the mixture, followed by concentration by evaporation, ultrafiltration, or the like (see JP S47-001964A, JP H1-023412B, JP H4-055125B, and JP H4-055127B). However, there have been many reports suggesting that non-spherical particles also can be produced by slightly modifying the steps of the same process. For example, since active silica is very unstable, a silica sol having a long and narrow shape can be produced by intentionally adding a polyvalent metal ion of Ca, Mg or the like. Further, non-spherical silica can be produced by varying the temperature of the reaction vessel (a temperature above the boiling point of water causes water to evaporate, and silica is dried at the gas-liquid interface), the pH of the reaction vessel (the connection of silica particles tends to occur at a pH of 9 or less), SiO₂/M₂O (M is alkali metal or quaternary ammonium) and the molar ratio (non-spherical silica is selectively produced at 30 to 60) of the reaction vessel (see JP H08-005657B, Japanese Patent No. 2803134, JP 2006-80406A, and JP 2007-153671A). Accordingly, with B) above, the ΔCV value can be adjusted to be small by controlling the process in a known production process for spherical colloidal silica so as to avoid conditions where non-spherical silica is locally produced.

The method for adjusting the particle size distribution of colloidal silica is not particularly limited. For example, a desired particle distribution can be obtained by adding new seed particles to the particles in a growing process during the production stage or by mixing two or more kinds of silica particles having different particle size distributions from each other.

[Other Components]

The polishing composition of the present invention can be mixed with other components as needed. Examples of such other components include a thickener, a dispersing agent, an anticorrosion agent, a basic substance, and a surfactant. The proportion of the other optional components relative to the polishing composition is preferably in a range of 0 to 10 wt %, and more preferably 0 to 5 wt %. However, the polishing composition of the present invention can exert the effect of reducing scratches and nanoprotrusion defects on the substrate surface after polishing, without containing the other components, in particular, a surfactant. Furthermore, the polishing composition of the present invention may contain alumina abrasive grains, and can be used for a rough polishing step performed before the final polishing step.

[pH of Polishing Composition]

From the viewpoint of increasing the polishing rate, the pH of the polishing composition of the present invention is preferably 3.0 or less, more preferably 2.5 or less, and still more preferably 2.0 or less. Furthermore, from the viewpoint of reducing scratches and nanoprotrusion defects on the substrate surface after polishing, the pH of the polishing composition of the present invention is preferably 0.5 or more, more preferably 0.8 or more, still more preferably 1.0 or more, and even more preferably 1.2 or more. From the viewpoint of increasing the polishing rate, the pH of liquid wastes of the polishing composition is preferably 3 or less, more preferably 2.5 or less, still more preferably 2.2 or less, and even more preferably 2.0 or less. From the viewpoint of reducing scratches and nanoprotrusion defects on the substrate surface after polishing, the pH of liquid wastes of the polishing composition is preferably 0.8 or more, more preferably 1.0 or more, still more preferably 1.2 or more, and even more preferably 1.5 or more. Note that the pH of the liquid wastes refers to the pH of the polishing liquid wastes in a polishing step using the polishing composition, that is, the polishing composition immediately after being discharged from a polishing machine.

[Method for Preparing Polishing Composition]

The polishing composition of the present invention can be prepared, for example, by mixing an abrasive, an acid, an oxidizing agent, a heterocyclic aromatic compound, an aliphatic amine compound, water, and, as needed, other components by a known method. In so doing, the abrasive may be mixed in the form of concentrated slurry, or may be mixed after being diluted with water or the like. The proportion and concentration of each component in the polishing composition of the present invention are within the above-described ranges. However, in another aspect, the polishing composition of the present invention may be prepared in the form of concentrate.

[Substrate to be Polished]

A substrate to be polished using the polishing composition of the present invention is a Ni—P-plated aluminum alloy substrate. By using the polishing composition of the present invention in polishing a Ni—P-plated aluminum alloy substrate, it is not only possible to reduce scratches on the substrate surface after polishing but also possible to reduce nanoprotrusion defects on the substrate surface after polishing as an effect beyond conventional expectations.

[Method for Producing Magnetic Disk Substrate]

Viewed from another aspect, the present invention relates to a method for producing a magnetic disk substrate (hereinafter, also referred to as “the production method of the present invention”). The production method of the present invention is a method for producing a magnetic disk substrate, which includes a step of polishing a substrate to be polished using the above-described polishing composition of the present invention (hereinafter, also referred to as, “the polishing step using the polishing composition of the present invention”). Accordingly, it is possible to preferably provide a magnetic disk substrate with reduced nanoprotrusion defects as well as scratches on the substrate surface after polishing. The production method of the present invention is particularly suitable for a method for producing a magnetic disk substrate for the perpendicular magnetic recording system. Thus, viewed from another aspect, the production method of the present invention is a method for producing a magnetic disk substrate for the perpendicular magnetic recording system, which includes the polishing step using the polishing composition of the present invention.

Specific examples of the method for polishing a substrate to be polished using the polishing composition of the present invention include a method in which a substrate to be polished is sandwiched between platens to which a polishing pad such as an organic polymer-based polishing cloth in the form of nonwoven fabric is attached, and the substrate to be polished is polished by moving the platens and the substrate to be polished, while feeding the polishing composition of the present invention to a polishing machine. Therefore, the production method of the present invention includes supplying a polishing composition to a target surface of a substrate to be polished, brining a polishing pad into contact with the target surface and polishing by moving the polishing pad or the substrate to be polished.

When the polishing process of the substrate to be polished is performed in multiple steps, the polishing step using the polishing composition of the present invention is performed preferably at the second or later stage, more preferably at the final polishing step. In so doing, in order to prevent the entry of the abrasive and the polishing composition that have been used in the preceding step, separate polishing machines may be used for each step. When separate polishing machines are used for each step, it is preferable to dean the substrate to be polished after each polishing step. Note that there is no particular limitation to the polishing machine, and it is possible to use any known polishing machine for polishing magnetic disk substrates.

[Polishing Pad]

There is no particular limitation to the polishing pad used in the present invention, and it is possible to use a suede type, nonwoven fabric type, or polyurethane dosed-cell type polishing pad, or a two-layer type polishing pad in which such polishing pads are laminated. However, from the viewpoint of the polishing rate, a suede type polishing pad is preferable.

From the viewpoints of reducing scratches and of the service life of the pad, the average pore diameter of the surface of the polishing pad is preferably 50 μm or less, more preferably 45 μm or less, still more preferably 40 μm or less, and even more preferably 35 μm or less. From the viewpoint of the ability of the pad to retain the polishing liquid, in order to retain the polishing liquid by the pores and prevent depletion of the liquid, the average pore diameter is preferably 0.01 μm or more, more preferably 0.1 μm or more, still more preferably 1 μm or more, and even more preferably 10 μm or more. From the viewpoint of maintaining the polishing rate, the maximum pore diameter of the polishing pad is preferably 100 μm or less, more preferably 70 μm or less, still more preferably 60 μm or less, and even more preferably 50 μm or less.

[Polishing Load]

The polishing load in the polishing step using the polishing composition of the present invention is preferably 5.9 kPa or more, more preferably 6.9 kPa or more, and still more preferably 7.5 kPa or more. This can prevent reduction in the polishing rate, thus improving the productivity. Note that the polishing load in the production method of the present invention refers to the pressure applied by the platens to the polished surface of the substrate to be polished during polishing. In the polishing step using the polishing composition of the present invention, the polishing load is preferably 20 kPa or less, more preferably 18 kPa or less, and still more preferably 16 kPa or less. This can prevent the occurrence of scratches. Therefore, in the polishing step using the polishing composition of the present invention, the polishing load is preferably 5.9 to 20 kPa, more preferably 6.9 to 18 kPa, and still more preferably 7.5 to 16 kPa. The polishing load can be adjusted by loading at least either the platens or the substrate to be polished with air pressure, a weight, or the like.

[Feeding of Polishing Composition]

From the viewpoint of reducing scratches, the feeding rate of the polishing composition of the present invention in the polishing step using the polishing composition of the present invention is preferably 0.05 to 15 mL/min, more preferably 0.06 to 10 mL/min, still more preferably 0.07 to 1 mL/min, even more preferably 0.08 to 0.5 mL/min, and still even more preferably 0.12 to 0.5 mL/min, per cm² of the substrate to be polished.

Examples of the method for feeding the polishing composition of the present invention to the polishing machine include a method in which the composition is continuously fed, for example, with a pump. When feeding the polishing composition to the polishing machine, it is possible to adopt a method in which the polishing composition is fed as a single liquid containing all components. In addition, it is also possible to divide the polishing composition into a plurality of blending component liquids in consideration of the stability and the like of the polishing composition, and feed the polishing composition as two or more liquids. In the latter case, the plurality of blending component liquids are mixed together, for example, in a feeding pipe or on the substrate to be polished, to serve as the polishing composition of the present invention.

According to the present invention, it is possible to provide a magnetic disk substrate with reduced nanoprotrusion defects as well as scratches on the substrate surface after polishing, and the present invention therefore can be suitably used for polishing a magnetic disk substrate for the perpendicular magnetic recording system, for which a high level of surface smoothness is required.

There is no particular limitation to the shape of the above-described substrate to be polished, and the substrate may have any shape having a planar portion, including, for example, a disk shape, a plate shape, a slab shape, and a prism shape, or any shape having a curved portion, including, for example, a lens. In particular, a disk-shaped substrate to be polished is suitable. For a disk-shaped substrate to be polished, the outer diameter thereof is about 2 to 95 mm, for example, and the thickness thereof is about 0.5 to 2 mm, for example.

[Polishing Method]

Viewed from another aspect, the present invention relates to a method for polishing a substrate to be polished, which includes polishing the substrate to be polished, while keeping the above-described polishing composition in contact with the polishing pad. Specifically, the present invention relates to a polishing method including supplying a polishing composition to a target surface of a substrate to be polished, brining a polishing pad into contact with the target surface, and polishing by moving the polishing pad or the substrate to be polished. By using the polishing method of the present invention, a magnetic disk substrate, in particular, a magnetic disk substrate for the perpendicular magnetic recording system with reduced nanoprotrusion defects as well as scratches on the substrate surface after polishing is preferably provided. As described above, examples of the above-mentioned substrate to be polished used in the polishing method of the present invention include those used for producing a magnetic disk substrate and a substrate for a magnetic recording medium. Of these, substrates used for a magnetic disk substrate for the perpendicular magnetic recording system are preferable. Note that, as the specific method and conditions for polishing, those described above can be adopted.

### EXAMPLES

### Examples 1 to 27 and Comparative Examples 1 to 11

Polishing compositions of Examples 1 to 27 and Comparative Examples 1 to 11 were prepared and substrates to be polished were polished using the compositions. After the polishing, scratches and nanoprotrusion defects on the substrates were evaluated. Table 1 below provides the results of the evaluation. The polymers, the method for preparing the polishing compositions, the method for measuring each parameter, the polishing conditions (polishing method) and the evaluation method used are as follows. In Table 1, BTA is an abbreviation of 1H-benzotriazole, AEEA is an abbreviation of N-aminoethylethanolamine, DETA is an abbreviation of diethylenetriamine, TETA is an abbreviation of triethylenetetraamine, TEPA is an abbreviation of tetraethylenepentamine, PEHA is an abbreviation of pentaethylenehexamine, and PEI is an abbreviation of polyethyleneimine (molecular weight: 600).

[Water-Soluble Polymer Having Anionic Group]

The following anionic polymers A to C-3 were used in the polishing compositions. The anionic polymer B was produced by the following method. Furthermore, the weight-average molecular weight of each polymer was measured under the following conditions.

### <Anionic Polymers>

A: acrylic acid/acrylamide-2-methylpropanesulfonic acid copolymer sodium salt (molar ratio: 90/10, weight-average molecular weight: 2,000, manufactured by Toagosei Co., Ltd.)
B: styrene/styrenesulfonic acid copolymer sodium salt (molar ratio: 33/67, weight-average molecular weight: 10,000, produced by the following method)
C-1: polyacrylic acid sodium salt (weight-average molecular weight: 2,000, manufactured by Toagosei Co., Ltd.)
C-2: polyacrylic acid sodium salt (weight-average molecular weight: 6,000, manufactured by Toagosei Co., Ltd.)
C-3: polyacrylic acid sodium salt (weight-average molecular weight: 20,000, manufactured by Kao Co., Ltd.)

[Production Method of Styrene/Styrenesulfonic Acid Copolymer Sodium Salt]

A 1 L four-necked flask was charged with 180 g of isopropyl alcohol (manufactured by Kishida Chemical Co., Ltd.), 270 g of ion exchanged water, 10 g of styrene (manufactured by Kishida Chemical Co., Ltd.), and 40 g of sodium styrene, sulfonate (manufactured by Wako Pure Chemical Industries, Ltd), and 7.2 g of 2,2′-azobis(2-methylpropionamidine) dihydrochloride (V-50, manufactured by Wako Pure Chemical Industries, Ltd.) was added as an initiator. They were polymerized dropwise for two hours at 83±2° C., further aged for two hours, and the solvent was thereafter removed under reduced pressure to give a white powder of the polymer B.

[Measurement Method for Weight-Average Molecular Weight of Polymers]

The weight-average molecular weight of each polymer was measured using gel permeation chromatography (GPC) under the following measurement conditions. AA/AMPS is an abbreviation of acrylic acid/acrylamide-2-methylpropanesulfonic acid copolymer sodium salt, PAA is an abbreviation of polyacrylic acid sodium salt, and St/SS is an abbreviation of styrene/styrenesulfonic acid copolymer sodium salt.

[GPC conditions for AA/AMPS and PAA]

Column: TSKgel G4000PWXL+TSKgel G2500PWXL (manufactured by Tosoh Corporation)

Guard Column: TSKguardcolumn PWXL (manufactured by Tosoh Corporation)

Eluent: 0.2M phosphate buffer/CH₃CN=9/1 (volume ratio)

Temperature=40° C.

Flow Rate: 1.0 mL/min

Sample Size: 5 mg/mL

Detector: RI

Standard for Calculation: sodium polyacrylate (molecular weight (Mp): 115,000, 28,000, 4,100, 1,250 (manufactured by Sowa Science Corporation and American Polymer Standards Corp.))

### [GPC Conditions for St/SS]

Column: TSKgel α-M+TSKgel α-M (manufactured by Tosoh Corp.)

Guard Column: TSKguardcolumn a (manufactured by Tosoh Corp.)

Eluent: 60 mmol/L phosphoric acid, 50 mmol/L LiBr/DMF

Temperature: 40° C.

Flow Rate: 1.0 mL/min

Sample Size: 5 mg/mL

Detector: RI

Standard for Calculation: polystyrene (molecular weight (Mw): 590, 3,600, 30,000, 96,400, 929,000, 8,420,000 (manufactured by Tosoh Corp., Nishio Kogyo, and Chemco Scientific Co.,)

[Method for Preparing Polishing Compositions]

The polishing compositions of Examples 1 to 27 and Comparative Examples 1 to 11 were prepared using the heterocyclic aromatic compounds, the aliphatic amine compounds or alicyclic amine compounds, the colloidal silicas (manufactured by JGC Catalysts and Chemicals Ltd.), the anionic polymers, the acid (sulfuric acid), and the oxidizing agent (hydrogen peroxide) shown in Table 1. Although the concentration of colloidal silica, the amount of the anionic polymer added and the concentration of sulfuric acid were set to 5 wt %, 0.05 wt % and 0.5 wt %, respectively, they were set to 0.3 wt %, 0.2 wt % and 0.1 wt %, respectively, in Examples 26 and 27 and Comparative Example 9. In Comparative Example 1, 2.0 wt % of orthophosphoric acid was used in place of sulfuric acid and 0.8 wt % of K₂HPO₄ was also used Sulfuric acid was not used in Comparative Examples 10 and 11, and 0.05 wt % of NaOH was used in Comparative Example 11. 0.4 wt % of hydrogen peroxide was used in all of Examples and Comparative Examples except Comparative Example 8.

The average particle size, CV90 and ΔCV of the colloidal silica based on a scattering intensity distribution were measured by the following methods.

[Methods for Measuring Average Particle Size, CV90 and ΔCV Value of Colloidal Silica Measured by Dynamic Light Scattering]

### [Average Particle Size and CV90]

The colloidal silicas, sulfuric acid, and a hydrogen peroxide solution were added to ion exchanged water, and these ingredients were mixed to give standard samples. The proportions of the colloidal silicas, sulfuric acid, and hydrogen peroxide relative to the standard samples were 5.0 wt %, 0.5 wt %, and 0.4 wt %, respectively. For each of the standard samples, the area in the scattering intensity distribution at a detection angle of 90° was obtained by the Cumulant method by performing 200 times of integration using a dynamic light scattering DLS-6500 manufactured by Otsuka Electronics Co., Ltd. in accordance with the instructions provided by the manufacturer Then, the particle size for which the above-described area constitutes 50% of the total area was determined, and this was used as the average particle size of the colloidal silica. As for the CV value of the colloidal silicas at a detection angle of 90° (CV90), a value was calculated by dividing the standard deviation in the scattering intensity distribution measured in accordance with the above-described measurement method by the above-described average particle size and multiplying the result by 100.

### [ΔCV Value]

Similarly to the measurement method of CV90 described above, the CV value of each of the colloidal silicas at a detection angle of 30° was measured, and a value obtained by subtracting CV90 from CV30 was used as the ΔCV value of the silica particles.

### (Measurement Conditions of DLS-6500)

Detection Angle: 90°

Sampling Time: 4 (μm)

Correlation Channel: 256 (ch)

Correlation Method: TI

Sampling Temperature: 26.0 (° C.)

Detection Angle: 30°

Sampling Time: 10 (μm)

Correlation Channel: 1024 (ch)

Correlation Method: TI

Sampling Temperature: 26.0 (° C.)

[Polishing]

Using the polishing compositions of Examples 1 to 27 and Comparative Examples 1 to 11 prepared as described above, the substrate to be polished described below was polished under the polishing conditions described below. Then, nanoprotrusion defects and scratches in the polished substrate were measured in accordance with the conditions described below, and evaluation was carried out. The results are shown in Table 1. The data shown in Table 1 was obtained as follows: After polishing four substrates to be polished for each of the examples and the comparative examples, both sides of each substrate to be polished were measured, and the average of the data for the four substrates (a total of eight surfaces, including both sides) was obtained.

[Substrate to be Polished]

As the substrate to be polished, a substrate resulting from subjecting a Ni—P-plated aluminum alloy substrate to rough polishing in advance with a polishing composition containing an alumina abrasive was used. In addition, this substrate to be polished had an thickness of 1.27 mm, an outer diameter of 95 nun, and an inner diameter of 25 mm, a center line average roughness Ra measured with AFM (Digital Instrument NanoScope IIIa Multi Mode AFM) of 1 nm, an amplitude of long-wavelength waviness (wavelength of 0.4 to 2 mm) of 2 nm, and an amplitude of short-wavelength waviness (wavelength of 50 to 400 μm) of 2 nm.

[Polishing Conditions]

Polishing test machine: “Double side 9B polisher” manufactured by SpeedFam Company Limited

Polishing Pad: suede type (thickness: 0.9 mm, average pore diameter: 30 μm) manufactured by FUJIBO HOLDINGS INC.

Amount of Polishing Composition Fed: 100 mL/min (feeding rate per cm² of substrate to be polished: 0.072 mL/min)

Number of Revolutions of Lower Platen: 32.5 rpm

Polishing Load: 7.9 kPa

Polishing Time: 8 min

[Method for Measuring Polishing Rate]

The weight of each of the substrates was measured using a weighing instrument (“BP-210S”, manufactured by Sartorius) before and after polishing, and a change in weight was determined for each substrate. An average value of 10 substrates was taken as the amount reduced, and a value obtained by dividing the amount reduced by the polishing time was taken as the rate of weight reduction. The rate of weight reduction was introduced in the following equation, and converted to a polishing rate (μm/min).

Polishing rate (μm/min)=Rate of weight reduction (g/min)/Area of one side of substrate (mm²)/Ni—P plating density (g/cm³)×10⁶

(calculated taking the area of one side of the substrate as 6597 mm², and the Ni—P plating density as 7.99 g/cm³)

[Method for Evaluating Nanoprotrusion Defects and Scratches]

Measurement apparatus: OSA6100, manufactured by KLA Tencor Corporation

Evaluation: Four substrates were randomly selected from the substrates placed in the polishing test machine, and each of the substrates was irradiated with laser light at 10000 rpm, and nanoprotrusion defects and scratches were measured. The total numbers of the nanoprotrusion defects and the scratches present on both sides of each of the four substrates were each divided by 8 to give the numbers of nanoprotrusion defects and scratches per substrate. The results are shown in Table 1 as relative values, with Comparative Example 1 taken as 100. In Table 1, “not measurable” means that the nanoprotrusion defects or the number of scratches has exceeded the measurement upper limit due to flaws caused by rough polishing resulting from a slow polishing rate or due to incomplete removal of an abrasive residue.

TABLE 1

| | | | | | Aliphatic amine compound | | | | | | | | | | | | | |
|---|---|---|---|---|---|---|---|---|---|---|---|---|---|---|---|---|---|---|
| | | | | | or | | | | Colloidal silica | | | | | | | | | |
| | | Heterocyclic aromatic compound | | | Alicyclic amine compound | | | | Average | | | | Oxidizing | | | Polishing evaluation | | |
| | | | Number | Amount | | Number | Amount | Anionic | particle | | | Acid | Agent | | Polishing | Polishing | | |
| | | | of nitrogen | added | | of nitrogen | added | polymer | size | CV90 | ΔCV | (sulfuric | (hydrogen | | solution | rate | | Nano- |
| | | Type | atoms | wt % | Type | atoms | wt % | Type | nm | % | % | acid) | peroxide) | Other | pH | um/rnin | Scratches | protrusions |
| Example | 1 | BTA | 3 | 0.1 | AEEA | 2 | 0.05 | — | 27 | 23 | 11.6 | 0.5% | 0.4% | — | 1.4 | 0.10 | 79.0 | 67.4 |
| | 2 | BTA | 3 | 0.1 | AEEA | 2 | 0.05 | — | 32 | 37 | 9.5 | 0.5% | 0.4% | — | 1.4 | 0.12 | 86.2 | 88.5 |
| | 3 | BTA | 3 | 0.1 | AEEA | 2 | 0.05 | — | 41 | 25 | 4.8 | 0.5% | 0.4% | — | 1.4 | 0.11 | 85.2 | 75.8 |
| | 4 | BTA | 3 | 0.1 | AEEA | 2 | 0.05 | — | 27 | 22 | 2.9 | 0.5% | 0.4% | — | 1.4 | 0.10 | 20.8 | 18.9 |
| | 5 | BTA | 3 | 0.1 | AEEA | 2 | 0.05 | A | 27 | 23 | 11.6 | 0.5% | 0.4% | — | 1.4 | 0.09 | 21.2 | 40.8 |
| | 6 | BTA | 3 | 0.1 | AEEA | 2 | 0.01 | A | 27 | 22 | 2.9 | 0.5% | 0.4% | — | 1.4 | 0.09 | 10.8 | 15.3 |
| | 7 | BTA | 3 | 0.1 | AEEA | 2 | 0.025 | A | 27 | 22 | 2.9 | 0.5% | 0.4% | — | 1.4 | 0.09 | 7.6 | 16.0 |
| | 8 | BTA | 3 | 0.1 | AEEA | 2 | 0.05 | A | 27 | 22 | 2.9 | 0.5% | 0.4% | — | 1.4 | 0.09 | 5.9 | 14.1 |
| | 9 | BTA | 3 | 0.1 | AEEA | 2 | 0.1 | A | 27 | 22 | 2.9 | 0.5% | 0.4% | — | 1.4 | 0.09 | 6.7 | 16.0 |
| | 10 | BTA | 3 | 0.2 | AEEA | 2 | 0.05 | A | 27 | 22 | 2.9 | 0.5% | 0.4% | — | 1.4 | 0.08 | 2.5 | 7.5 |
| | 11 | pyridazine | 2 | 0.1 | AEEA | 2 | 0.05 | A | 27 | 22 | 2.9 | 0.5% | 0.4% | — | 1.4 | 0.09 | 6.6 | 13.6 |
| | 12 | pyrazine | 2 | 0.1 | AEEA | 2 | 0.05 | A | 27 | 22 | 2.9 | 0.5% | 0.4% | — | 1.4 | 0.09 | 10.6 | 16.8 |
| | 13 | 1H-tetrazole | 4 | 0.1 | AEEA | 2 | 0.05 | A | 27 | 22 | 2.9 | 0.5% | 0.4% | — | 1.4 | 0.08 | 6.1 | 13.9 |
| | 14 | tolyl triazole | 3 | 0.1 | AEEA | 2 | 0.05 | A | 27 | 22 | 2.9 | 0.5% | 0.4% | — | 1.4 | 0.09 | 5.9 | 15.4 |
| | 15 | 1,2,3-triazole | 3 | 0.1 | AEEA | 2 | 0.05 | A | 27 | 22 | 2.9 | 0.5% | 0.4% | — | 1.4 | 0.09 | 6.5 | 14.6 |
| | 16 | BTA | 3 | 0.1 | ethylene- | 2 | 0.05 | A | 27 | 22 | 2.9 | 0.5% | 0.4% | — | 1.4 | 0.09 | 7.1 | 12.8 |
| | | | | | diamine | | | | | | | | | | | | | |
| | 17 | BTA | 3 | 0.1 | N-aminoethyl | 2 | 0.05 | A | 27 | 22 | 2.9 | 0.5% | 0.4% | — | 1.4 | 0.09 | 7.8 | 15.6 |
| | | | | | isopropanol | | | | | | | | | | | | | |
| | | | | | amine | | | | | | | | | | | | | |
| | 18 | BTA | 3 | 0.1 | N-aminoethyl | 2 | 0.05 | A | 27 | 22 | 2.9 | 0.5% | 0.4% | — | 1.4 | 0.09 | 6.9 | 12.8 |
| | | | | | N-methyl | | | | | | | | | | | | | |
| | | | | | ethanolamine | | | | | | | | | | | | | |
| | 19 | BTA | 3 | 0.1 | piperazine | 2 | 0.05 | A | 27 | 22 | 2.9 | 0.5% | 0.4% | — | 1.4 | 0.09 | 7.3 | 15.1 |
| | 20 | BTA | 3 | 0.1 | DETA | 3 | 0.05 | A | 27 | 22 | 2.9 | 0.5% | 0.4% | — | 1.4 | 0.09 | 11.3 | 20.3 |
| | 21 | BTA | 3 | 0.1 | TETA | 4 | 0.05 | A | 27 | 22 | 2.9 | 0.5% | 0.4% | — | 1.4 | 0.07 | 12.2 | 27.4 |
| | 22 | BTA | 3 | 0.1 | AEEA | 2 | 0.05 | B | 27 | 22 | 2.9 | 0.5% | 0.4% | — | 1.4 | 0.08 | 5.1 | 13.6 |
| | 23 | BTA | 3 | 0.1 | AEEA | 2 | 0.05 | C-1 | 27 | 22 | 2.9 | 0.5% | 0.4% | — | 1.4 | 0.09 | 7.3 | 15.0 |
| | 24 | BTA | 3 | 0.1 | AEEA | 2 | 0.05 | C-2 | 27 | 22 | 2.9 | 0.5% | 0.4% | — | 1.4 | 0.09 | 8.1 | 15.6 |
| | 25 | BTA | 3 | 0.1 | AEEA | 2 | 0.05 | C-3 | 27 | 22 | 2.9 | 0.5% | 0.4% | — | 1.4 | 0.09 | 9.0 | 16.9 |
| | 26 | BTA | 3 | 0.1 | AEEA | 2 | 0.05 | A | 27 | 22 | 2.9 | 0.3% | 0.4% | — | 1.7 | 0.09 | 7.4 | 16.2 |
| | 27 | BTA | 3 | 0.1 | AEEA | 2 | 0.05 | A | 27 | 22 | 2.9 | 0.2% | 0.4% | — | 2.2 | 0.08 | 6.8 | 15.7 |
| Comp. | 1 | BTA | 3 | 0.1 | — | — | — | — | 27 | 23 | 11.6 | * ortho- | 0.62% | K₂HPO₄ | 1.7 | 0.10 | 100 | 100 |
| Ex. | | | | | | | | | | | | phosphoric | | | | | | |
| | | | | | | | | | | | | acid | | | | | | |
| | | | | | | | | | | | | 2.0% | | | | | | |
| | 2 | — | — | — | AEEA | 2 | 0.05 | — | 27 | 23 | 11.6 | 0.5% | 0.4% | — | 1.4 | 0.09 | 178.6 | 103.2 |
| | 3 | BTA | 3 | 0.1 | mono- | 1 | 0.05 | — | 27 | 23 | 11.6 | 0.5% | 0.4% | — | 1.4 | 0.10 | 86.5 | 109 |
| | | | | | ethanolamine | | | | | | | | | | | | | |
| | 4 | BTA | 3 | 0.1 | piperidine | 1 | 0.05 | — | 27 | 23 | 11.6 | 0.5% | 0.4% | — | 1.4 | 0.10 | 92.6 | 112 |
| | 5 | BTA | 3 | 0.1 | TEPA | 5 | 0.05 | — | 27 | 23 | 11.6 | 0.5% | 0.4% | — | 1.4 | 0.04 | not | not |
| | | | | | | | | | | | | | | | | | measurable | measurable |
| | 6 | BTA | 3 | 0.1 | PEHA | 6 | 0.05 | — | 27 | 23 | 11.6 | 0.5% | 0.4% | — | 1.4 | 0.03 | not | not |
| | | | | | | | | | | | | | | | | | measurable | measurable |
| | 7 | BTA | 3 | 0.1 | PEI | polyvalent | 0.05 | — | 27 | 23 | 11.6 | 0.5% | 0.4% | — | 1.4 | 0.02 | not | not |
| | | | | | | | | | | | | | | | | | measurable | measurable |
| | 8 | BTA | 3 | 0.1 | AEEA | 2 | 0.05 | — | 27 | 23 | 11.6 | 0.5% | — | — | 1.4 | 0.02 | not | not |
| | | | | | | | | | | | | | | | | | measurable | measurable |
| | 9 | BTA | 3 | 0.1 | AEEA | 2 | 0.05 | — | 27 | 23 | 11.6 | 0.1% | 0.4% | — | 3.2 | 0.03 | not | not |
| | | | | | | | | | | | | | | | | | measurable | measurable |
| | 10 | BTA | 3 | 0.1 | AEEA | 2 | 0.05 | — | 27 | 23 | 11.6 | — | 0.4% | — | 6.8 | 0.02 | not | not |
| | | | | | | | | | | | | | | | | | measurable | measurable |
| | 11 | BTA | 3 | 0.1 | AEEA | 2 | 0.05 | — | 27 | 23 | 11.6 | — | 0.4% | NaOH | 10 | 0.02 | not | not |
| | | | | | | | | | | | | | | 0.05% | | | measurable | measurable |

As can be seen from Table 1, nanoprotrusion defects as well as scratches on the substrate surface after polishing were reduced more by using the polishing compositions of Examples 1 to 27 than those of Comparative Examples 1 to 11.

According to the present invention, it is possible to provide a magnetic disk substrate suitable for achieving a higher recording density, for example.

The invention may be embodied in other forms without departing from the spirit of essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A method for polishing a substrate to be polished, comprising polishing a Ni—P-plated aluminum alloy substrate as the substrate to be polished while keeping a polishing composition in contact with a polishing pad,
wherein the polishing composition contains an abrasive, an acid, an oxidizing agent, a heterocyclic aromatic compound, an aliphatic amine compound or alicyclic amine compound, and water, the heterocyclic aromatic compound includes two or more nitrogen atoms in its ring structure, the aliphatic amine compound or alicyclic amine compound includes two to four nitrogen atoms in its molecules, and the polishing composition has a pH of 3.0 or less.

2. The method according to claim 1, wherein the heterocyclic aromatic compound is selected from the group consisting of pyrimidine, pyrazine, pyridazine, 1,2,3-triazine, 1,2,4-triazine, 1,2,5-triazine, 1,3,5-triazine, 1,2,4-oxadiazole, 1,2,5-oxadiazole, 1,3,4-oxadiazole, 1,2,5-thiadiazole, 1,3,4-thiadiazole, 3-aminopyrazole, 4-aminopyrazole, 3,5-dimethylpyrazole, pyrazole, 2-aminoimidazole, 4-aminoimidazole, 5-aminoimidazole, 2-methylimidazole, 2-ethylimidazole, imidazole, benzoimidazole, 1,2,3-triazole, 4-amino-1,2,3-triazole, 5-amino-1,2,3-triazole, 1,2,4-triazole, 3-amino-1,2,4-triazole, 5-amino-1,2,4-triazole, 3-mercapto-1,2,4-triazole, 1H-tetrazole, 5-aminotetrazole, 1H-benzotriazole, 1H-tolyltriazole, 2-aminobenzotriazole, 3-aminobenzotriazole and an alkyl-substituted product thereof.

3. The method according to claim 1, wherein the aliphatic amine compound is selected from the group consisting of ethylenediamine, N,N,N′,N′-tetramethylethylenediamine, 1,2-diaminopropane, 1,3-diaminopropane, 1,4-diaminobutane, hexamethylenediamine, 3-(diethylamino)propylamine, 3-(dibutylamino)propylamine, 3-(methylamino)propylamine, 3-(dimethylamino)propylamine, N-aminoethylethanolamine, N-aminoethylisopropanolamine, N-aminoethyl-N-methylethanolamine, diethylenetriamine, and triethylenetetraamine and the alicyclic amine compound is selected from the group consisting of piperazine, 2-methylpiperazine, 2,5-dimethylpiperazine, 1-amino-4-methylpiperzine, N-methylpiperzine, 1-(2-aminoethyl)piperazine, and hydroxyethylpiperazine.

4. The method according to claim 1, wherein the polishing composition further contains a water-soluble polymer having an anionic group.

5. A method for producing a magnetic disk substrate, comprising a step of polishing a Ni—P-plated aluminum alloy substrate using a polishing composition,
wherein the polishing composition contains an abrasive, an acid, an oxidizing agent, a heterocyclic aromatic compound, an aliphatic amine compound or alicyclic amine compound, and water, the heterocyclic aromatic compound includes two or more nitrogen atoms in its ring structure, the aliphatic amine compound or alicyclic amine compound includes two to four nitrogen atoms in its molecules, and the polishing composition has a pH of 3.0 or less.

6. The method according to claim 5, wherein the heterocyclic aromatic compound is selected from the group consisting of pyrimidine, pyrazine, pyridazine, 1,2,3-triazine, 1,2,4-triazine, 1,2,5-triazine, 1,3,5-triazine, 1,2,4-oxadiazole, 1,2,5-oxadiazole, 1,3,4-oxadiazole, 1,2,5-thiadiazole, 1,3,4-thiadiazole, 3-aminopyrazole, 4-aminopyrazole, 3,5-dimethylpyrazole, pyrazole, 2-aminoimidazole, 4-aminoimidazole, 5-aminoimidazole, 2-methylimidazole, 2-ethylimidazole, imidazole, benzoimidazole, 1,2,3-triazole, 4-amino-1,2,3-triazole, 5-amino-1,2,3-triazole, 1,2,4-triazole, 3-amino-1,2,4-triazole, 5-amino-1,2,4-triazole, 3-mercapto-1,2,4-triazole, 1H-tetrazole, 5-aminotetrazole, 1H-benzotriazole, 1H-tolyltriazole, 2-aminobenzotriazole, 3-aminobenzotriazole and an alkyl-substituted product thereof.

7. The method according to claim 5, wherein the aliphatic amine compound is selected from the group consisting of ethylenediamine, N,N,N′,N′-tetramethylethylenediamine, 1,2-diaminopropane, 1,3-diaminopropane, 1,4-diaminobutane, hexamethylenediamine, 3-(diethylamino)propylamine, 3-(dibutylamino)propylamine, 3-(methylamino)propylamine, 3-(dimethylamino)propylamine, N-aminoethylethanolamine, N-aminoethylisopropanolamine, N-aminoethyl-N-methylethanolamine, diethylenetriamine, and triethylenetetraamine and the alicyclic amine compound is selected from the group consisting of piperazine, 2-methylpiperazine, 2,5-dimethylpiperazine, 1-amino-4-methylpiperzine, N-methylpiperzine, 1-(2-aminoethyl)piperazine, and hydroxyethylpiperazine.

8. The method according to claim 5, wherein the polishing composition further contains a water-soluble polymer having an anionic group.
